(19) United States
(12) Patent Application Publication
(10) Pub. No.: US 2023/0062237 A1
(43) Pub. Date: Mar. 2, 2023

(54) MANAGEMENT METHODS AND SYSTEMS FOR ELECTRIC VEHICLE CHARGING EQUIPMENT

(71) Applicant: Noodoe Corporation, Taipei City (TW)

(72) Inventors: Yi-An Hou, Taipei City (TW); Chun-Hung Kung, Taipei City (TW); Chia-Hua Chang, Taipei City (TW); Yu-Ting Liou, Taipei City (TW); En-Yu Shih, Taipei City (TW); Yin-Ju Chou, Taipei City (TW)

(21) Appl. No.: 17/828,086

(22) Filed: May 31, 2022

(30) Foreign Application Priority Data
Aug. 27, 2021 (TW) 110131837
Aug. 27, 2021 (TW) 110131839

(51) Int. Cl. G06Q 20/10; B60L 53/30; B60L 53/68; G06K 7/14; G06F 8/61

(52) U.S. Cl. CPC G06Q 20/10; B60L 53/305; B60L 53/68; G06K 7/1417; G06F 8/61; B60L 2240/72

(57) ABSTRACT

Management methods and systems for electric vehicle charging equipment are provided. An application program of a mobile device scans a quick response code of an electric vehicle charging equipment to send a binding request to a server via a first network. In response to the binding request, the server determines whether the electric vehicle charging equipment has been bound to any account. When the electric vehicle charging equipment is not bound to any account, the server provides an interface to the mobile device to set account information. The server creates a specific account based on the account information, and sets the electric vehicle charging equipment to only accept a charging request from the specific account, wherein the application program is linked to the specific account.

### BACKGROUND OF THE INVENTION

### Field of the Invention

The disclosure relates generally to management methods and systems for electric vehicle charging equipment, and, more particularly to management methods and systems for electric vehicle charging equipment that can provide mechanisms for binding exclusive electric vehicle charging equipment for users.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, most of the power equipment in the field has already been constructed. It is expensive to update the power equipment, such as the capacity of the electric panel, and the construction time is very time-consuming. The number of electric vehicle charging stations that can be installed in a single charging field is limited by the existing maximum load capacity of the field. Therefore, in the case of limited electric vehicle charging stations, electric vehicle drivers may spend time waiting because the charging station is in use, or need to search for other nearby charging stations for charging operations, resulting in inconvenience in use, thereby reduce the willingness to drive an electric vehicle.

On the other hand, the charging scenarios of electric vehicles in a centralized residence, such as a community, will be more complicated than that of a general residence. In addition to the fact that the overall electricity consumption of the community is limited by the existing maximum load capacity, it is impossible to provide all households with electric vehicle charging stations. Since some households may have mechanical parking spaces, mechanical parking spaces are difficult to set up residents' private electric vehicle charging stations under the existing technology. Therefore, residents with mechanical parking spaces can only use public electric vehicle charging stations in the community, or must go to electric vehicle charging stations outside the community to charge their electric vehicles.

Further, different types of households may have different charging behaviors and patterns. For example, community residents may be tenants, and not all tenants have the need to charge electric vehicles. If the limited electric vehicle charging stations can be provided to the tenants who really have charging needs, the management of electric vehicle charging in the community will be more effective. Therefore, how to reduce the difficulty of installation and management of electric vehicle charging stations in the community and meet the charging needs of different households will be an urgent issue for the industry to solve.

### BRIEF SUMMARY OF THE INVENTION

In an embodiment of a management method for electric vehicle charging equipment is provided. First, an application program of a mobile device scans a quick response code of an electric vehicle charging equipment to send a binding request to a server via a first network. In response to the binding request, the server determines whether the electric vehicle charging equipment has been bound to any account. When the electric vehicle charging equipment is not bound to any account, the server provides an interface to the mobile device to set account information. The server creates a specific account based on the account information, and sets the electric vehicle charging equipment to only accept a charging request from the specific account, wherein the application program is linked to the specific account.

An embodiment of a management system for electric vehicle charging equipment comprises an electric vehicle charging equipment, a mobile device, and a server. The mobile device scans a quick response code of the electric vehicle charging equipment by using an application program, thus to transmit a binding request of the electric vehicle charging equipment to the server via a first network. In response to the binding request, the server determines whether the electric vehicle charging equipment has been bound to any account, and provides an interface to the mobile device to set account information when the electric vehicle charging equipment is not bound to any account. The server creates a specific account based on the account information, and sets the electric vehicle charging equipment to only accept a charging request from the specific account by the server, wherein the application program is linked to the specific account.

In some embodiments, the mobile device sets up a payment information through the application, and the server periodically performs a payment operation for the specific account according to the payment information.

In some embodiments, the server determines whether the periodic payment operation is completed, and suspends the right to use the electric vehicle charging equipment for the specific account when the periodic payment operation is not completed.

In some embodiments, the server provides an interface, wherein the interface has a service suspension function, and suspends the right to use the electric vehicle charging equipment for the specific account when the service suspension function is enabled.

In some embodiments, the mobile device scans the quick response code corresponding to the electric vehicle charging equipment by using the application program, thus to send a charging request corresponding to the electric vehicle charging equipment to the server via the first network, and in response to the charging request, the server transmits a charging authorization instruction to the electric vehicle charging equipment via a second network, so as to allow the electric vehicle charging equipment to perform a charging operation.

In some embodiments, the electric vehicle charging equipment transmits charging state data corresponding to the charging operation to the server via the second network, and the server transmits the charging state data to the mobile device via the first network, such that the charging state data is shown in the application of the mobile device.

In some embodiments, the server specifies the electric vehicle charging equipment among a plurality of candidate electric vehicle charging equipment, and sets communication data, creates the specific account based on the communication data, and sets the electric vehicle charging equipment to only accept charging requests of the specific account, sends an activation link to the mobile device according to the communication data, and the mobile device downloads and installs the application via the first network according to the activation link.

In some embodiments, the communication data comprises a telephone number, or an email address.

Management methods for electric vehicle charging equipment may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a management system for electric vehicle charging equipment of the invention:

FIG. 2 is a schematic diagram illustrating an embodiment of an electric vehicle charging station of the invention;

FIG. 3 is a schematic diagram illustrating an embodiment of a server of the invention:

FIG. 4 is a flowchart of an embodiment of a management method for electric vehicle charging equipment of the invention:

FIG. 5 is a flowchart of another embodiment of a management method for electric vehicle charging equipment of the invention;

FIG. 6 is a flowchart of another embodiment of a management method for electric vehicle charging equipment of the invention;

FIG. 7 is a flowchart of another embodiment of a management method for electric vehicle charging equipment of the invention;

FIG. 8 is a flowchart of another embodiment of a management method for electric vehicle charging equipment of the invention;

FIG. 9 is a flowchart of another embodiment of a management method for electric vehicle charging equipment of the invention;

FIG. 10 is a flowchart of another embodiment of a management method for electric vehicle charging equipment of the invention; and

FIG. 11 is a flowchart of another embodiment of a management method for electric vehicle charging equipment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

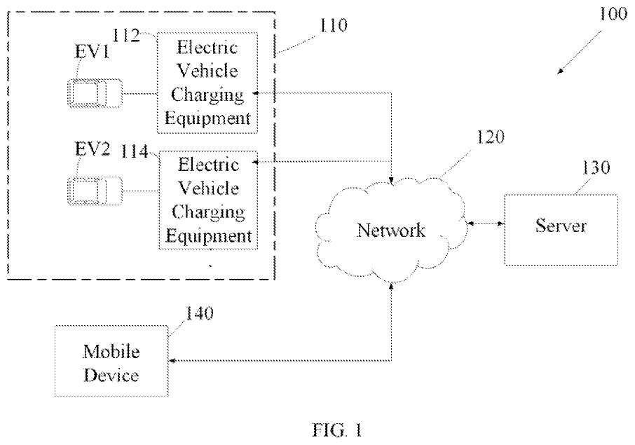

FIG. 1 is a schematic diagram illustrating an embodiment of a management system for electric vehicle charging equipment of the invention. The management system for electric vehicle charging equipment 100 is applicable to a plurality of electric vehicle charging equipment. It is understood that, in some embodiments, the electric vehicle charging equipment may be located within a charging field 110. For example, the charging field 110 may be a MDU (Multiple Dwelling Unit), a community, a building, a parking lot, or a shopping mall. Note that, in some embodiments, the charging field 110 may have a power limit. As shown in FIG. 1, the management system for electric vehicle charging equipment 100 of the present invention includes a plurality of electric vehicle charging equipment, such as 112 and 114, and a server 130 connected to the electric vehicle charging equipment 112, 114 via a network 120. The electric vehicle charging equipment 112 can provide the electric vehicle EV1 to perform a charging operation. Similarly, the electric vehicle charging equipment 114 can provide the electric vehicle EV2 to perform a charging operation. In some embodiments, the network 120 may be a wired network, a telecommunication network, a wireless network, such as a Wi-Fi network, or the like. The server 130 can receive various data from the electric vehicle charging equipment via the network 120, and transmit relevant signals to the electric vehicle charging equipment. The electric vehicle charging equipment can perform related operations according to the signals received from the server 130. For example, when the electric vehicle EV1 is coupled to the electric vehicle charging equipment 112 through a charging gun of the electric vehicle charging equipment 112 to perform a charging operation, the electric vehicle charging equipment 112 can charge the electric vehicle EV1 for the charging operation. The charging information is transmitted via the network 120, and the server 130 can receive the charging information of the corresponding charging operation from the electric vehicle charging equipment 112 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the charging equipment 112 to each other, such as inserting a charging gun into the charging port of the electric vehicle to send a charging request corresponding to the charging equipment 112 to use the charging equipment 112. The charging equipment 112 performs a charging operation for the electric vehicle EV1. Similarly, the user can connect the electric vehicle EV2 and the charging equipment 114 to each other, such as inserting a charging gun into the charging port of the electric vehicle to send a charging request corresponding to the charging equipment 114 to use the charging equipment 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the charging equipment 112 via the network 120, so that the charging equipment 112 outputs power to the electric vehicle EV1, such as an electric scooter or an electric car, which is electrically connected to it, or prohibits the charging equipment 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the charging equipment 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the charging equipment 112 to generate a corresponding charging request, and sent it to the server 130 via the network 120. It is reminded that, in some embodiments, each user can have an RFID card.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned, the charging field 110 may have a power limit. It is understood that, the server 130 can perform a load adjustment operation for the electric vehicle charging stations according to at least one energy management scheme. Specifically, the server 130 can generate an instruction and send the instruction to the respective charging station (112, 114) via the network 120 to control the charging station to output power for charging with a specified power parameter, such as a specified amperage, during a specific period of time to the electric vehicle connected to the station, or to prohibit the charging station from outputting power to the electric vehicle.

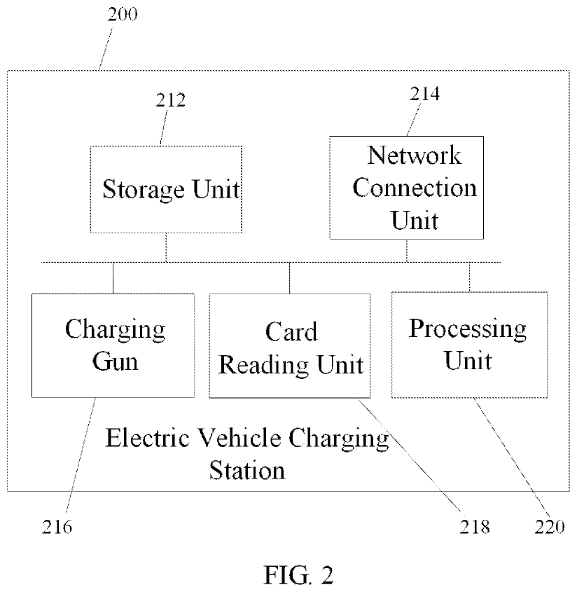

FIG. 2 is a schematic diagram illustrating an embodiment of an electric vehicle charging station of the invention. The electric vehicle charging station 200 shown in FIG. 2 can be applied to the charging equipment 112 and the second charging station 114 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a card reading unit 218, and a processing unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The card reading unit 218 may be an RFID reading unit for sensing information of a physical card, such as RFID card. The information sensed from the RFID card may be a card identification code and/or a user identification code of the physical card. The processing unit 220 can control the operations of related software and hardware in the electric vehicle charging station 200, and cooperate with the server 130 to execute the methods of the invention. Related details will be described later. It is noted that, in some embodiments, the processing unit 220 may be a general-purpose controller, a Micro-Control Unit, MCU, or a Digital Signal Processor, DSP, etc., to provide functions of data analysis, processing and calculation, but the present invention is not limited to this. In one embodiment, the processing unit 220 may use the network connection unit 214 to transmit the power state of the corresponding electric vehicle through a network for a cloud management server, such as the cloud server 130, for subsequent charging management. In another embodiment, the processing unit 220 can obtain the power parameter of a charging operation from the server 130, determine the output power according to the power parameter received from the server 130, and output the power to at least one electric vehicle through the charging gun 216 to perform the charging operation.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

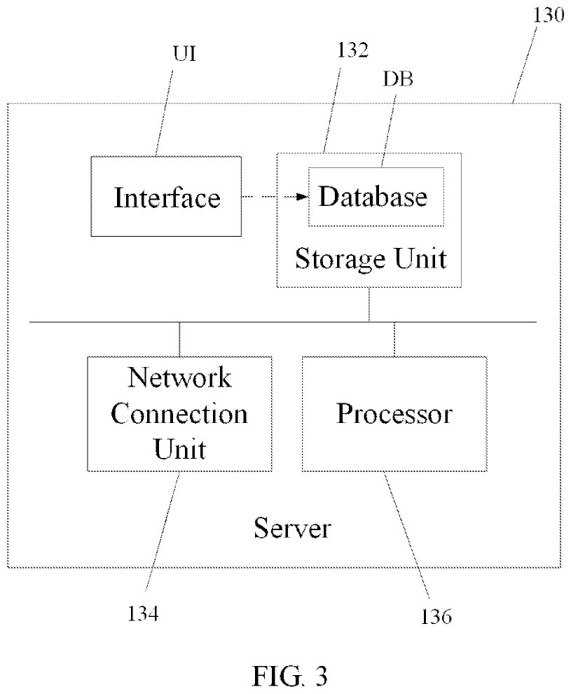

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging equipment in a charging field. The server 130 can directly or indirectly receive a charging request from a mobile device or a charging station, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 such as a memory, can store and record related data, such as various data of the corresponding electric vehicle charging equipment. The storage unit 132 may include a database DB for recording accounts bound to the corresponding electric vehicle charging equipment and account information thereof. It is understood that, in some embodiments, the respective electric vehicle charging equipment may be bound to an account. In other words, only the bound account can exclusively use the electric vehicle charging equipment. In some embodiments, the database DB can further record the payment information corresponding to the account bound to the electric vehicle charging equipment, the details of which will be described later. It is reminded that, in some embodiments, the server 130 may provide an interface UI for the user bound to the electric vehicle charging equipment to set the aforementioned data. Through the network connection unit 134, the server 130 can be coupled and communicated with the respective electric vehicle charging equipment via the network 120, such as a wired network, a telecommunication network, and a wireless network, such as a Wi-Fi network. The relevant data/signals/commands are transmitted to the electric vehicle charging equipment via the network 120 to control whether the electric vehicle charging equipment outputs electric power and specify the electric parameters to output electric power to charge the electric vehicle. The processor 136 can control the operations of the relevant software and hardware in the server 130, and execute the management methods for electric vehicle charging equipment of the present invention, the details of which will be described later. It should be noted that, in some embodiments, the processor 136 may be a general-purpose controller, a microcontroller, or a digital signal controller, etc., for providing data analysis, processing, and computing functions, but the present invention is not limited thereto.

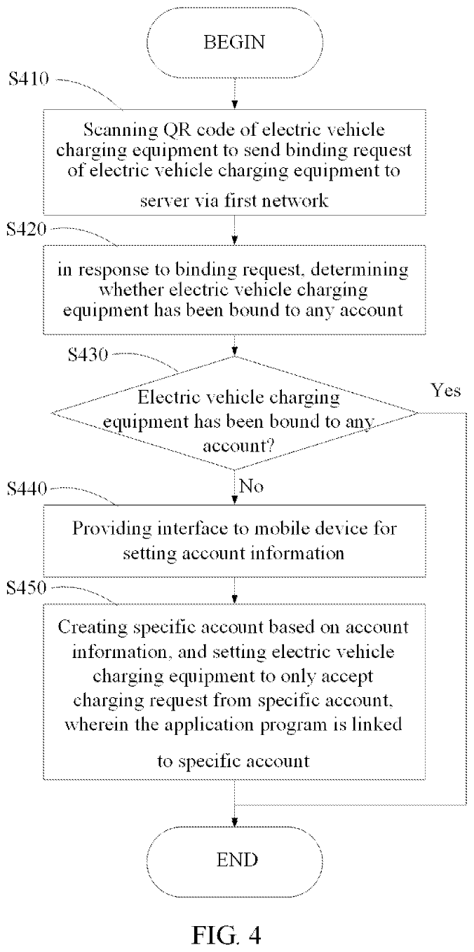

FIG. 4 is a flowchart of an embodiment of a management method for electric vehicle charging equipment of the invention. The management method for electric vehicle charging equipment of the invention is applicable to an electric vehicle charging equipment and a server.

In step S410, an application program of a mobile device is used to scan a QR code of the electric vehicle charging equipment, so as to send a binding request corresponding to the electric vehicle charging equipment to the server via a first network. In step S420, in response to the binding request, the server determines whether the electric vehicle charging equipment has been bound to any account. It is noted that, the binding request may comprise the identification data of the electric vehicle charging equipment. When the electric vehicle charging equipment has been bound to another account (Yes in step S430), the process ends. It should be noted that, in some embodiments, the server may send a specific message to the mobile device via the first network to notify that the electric vehicle charging equipment has been bound by another account. When the electric vehicle charging equipment is not bound to any account (No in step S430), in step S440, the server provides an interface to the mobile device through the application program for setting account information, and in step S450, the server creates a specific account according to the account information, and sets the electric vehicle charging equipment to accept only the charging requests corresponding to the specific account. It is noted that, the application program will be linked to this specific account after the binding is complete.

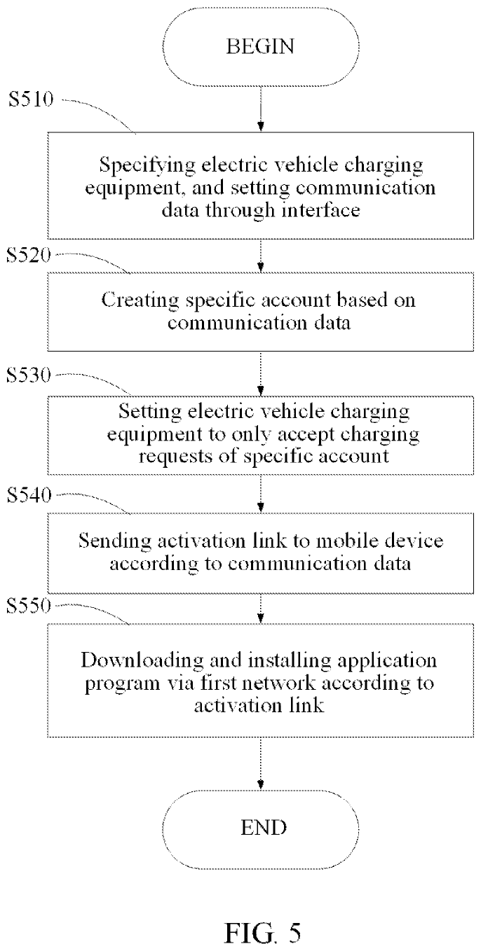

FIG. 5 is a flowchart of another embodiment of a management method for electric vehicle charging equipment of the invention. The management method for electric vehicle charging equipment of the invention is applicable to an electric vehicle charging equipment and a server.

In step S510, a specific electric vehicle charging equipment is specified from the electric vehicle charging equipment through an interface provided by the server, and a communication data is set. It should be reminded that an administrator of an electric vehicle charging equipment can perform the aforementioned operation and setting through the interface provided by the server. In some embodiments, the communication data comprises a phone number, and/or an email address. In step S520, the server creates a specific account according to the communication data, and in step S530, sets the specific electric vehicle charging equipment can only accept the charging requests corresponding to the specific account. Then, in step S540, the server transmits an activation link to a mobile device corresponding to a user according to the communication data. In step S550, the mobile device downloads and installs an application program via a network according to the activation link. Note that when the application program is installed on the mobile device, the application will automatically link and bind to the specific account.

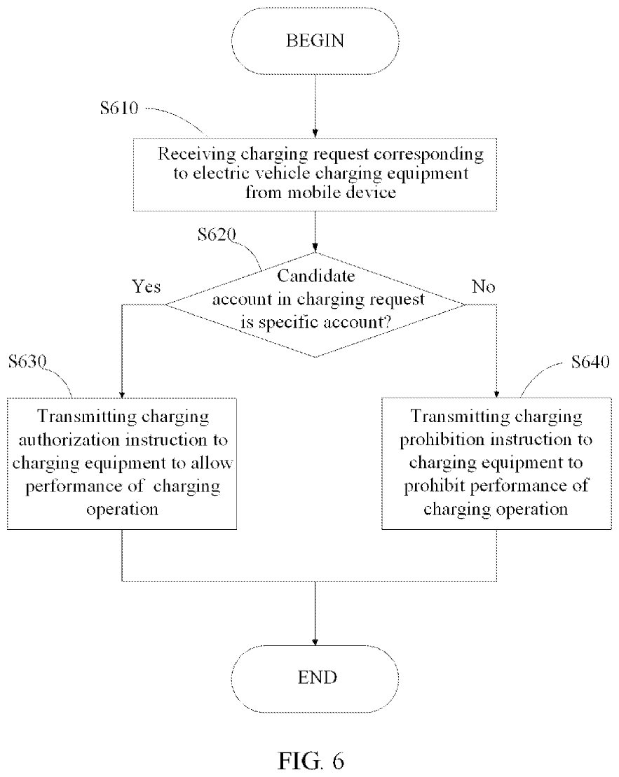

FIG. 6 is a flowchart of another embodiment of a management method for electric vehicle charging equipment of the invention. The management method for electric vehicle charging equipment of the invention is applicable to an electric vehicle charging equipment and a server. In this embodiment, the mobile device can make a charging request to the server.

In step S610, the server receives a charging request corresponding to the electric vehicle charging equipment from a mobile device. It should be noted that, in some embodiments, the mobile device can scan the QR code of the electric vehicle charging equipment by using the application program, so as to send a charging request of the electric vehicle charging equipment to the server via the first network. It is noted that, the charging request can record a candidate account associated with the application program. In step S620, the server determines whether the candidate account in the charging request is a specific account bound to the electric vehicle charging equipment. When the candidate account is the specific account (Yes in step S620), in step S630, the server transmits a charging authorization command to the electric vehicle charging equipment via a second network to allow the electric vehicle charging equipment to perform a charging operation. When the candidate account is not the specific account (No in step S620), in step S640, the server transmits a charging prohibition command to the electric vehicle charging equipment via the second network to prohibit the electric vehicle charging equipment from performing a charging operation. In other words, only the specific account bound to the electric vehicle charging equipment can use the electric vehicle charging equipment for charging operations.

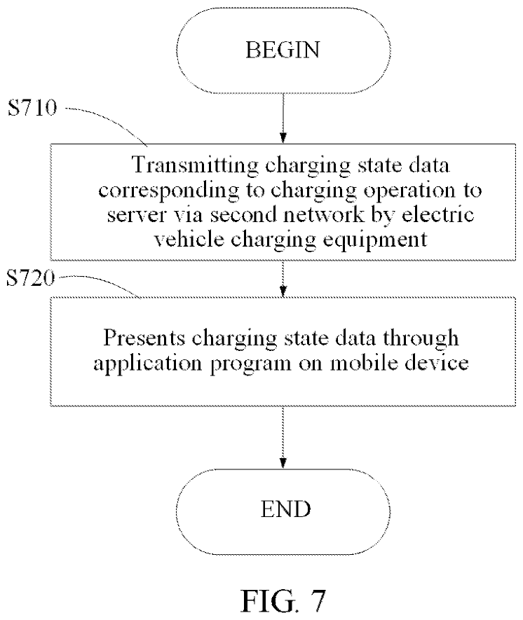

FIG. 7 is a flowchart of another embodiment of a management method for electric vehicle charging equipment of the invention. The management method for electric vehicle charging equipment of the invention is applicable to an electric vehicle charging equipment and a server. In this embodiment, the mobile device can know the relevant status of the charging operation. In step S710, during the execution of the charging operation, the electric vehicle charging equipment transmits a charging state of the charging operation to the server via the second network. Then, in step S720, the server presents the charging state in the application program of the mobile device through the first network.

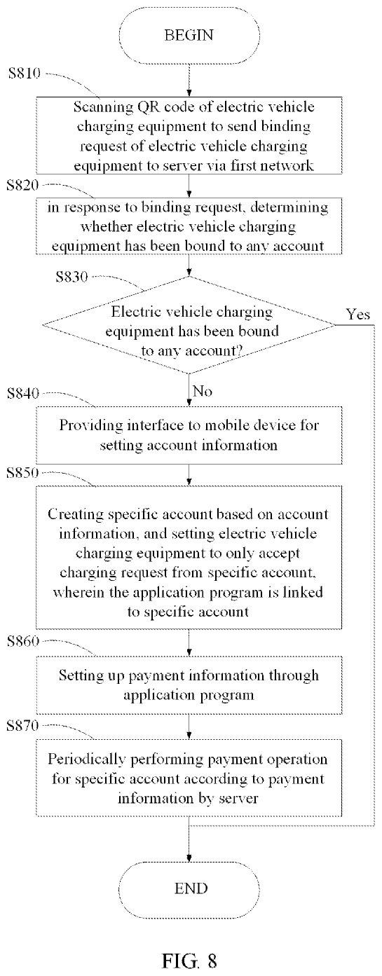

FIG. 8 is a flowchart of another embodiment of a management method for electric vehicle charging equipment of the invention. The management method for electric vehicle charging equipment of the invention is applicable to an electric vehicle charging equipment and a server. In this embodiment, the server will periodically request payment for a specific account of the mobile device.

In step S810, an application program of a mobile device is used to scan a QR code of the electric vehicle charging equipment, so as to send a binding request of the electric vehicle charging equipment to the server via a first network. In step S820, in response to the binding request, the server determines whether the electric vehicle charging equipment has been bound to any account. Similarly, the binding request comprises the identification data of the electric vehicle charging equipment. When the electric vehicle charging equipment has been bound to another account (Yes in step S830), the process ends. Similarly, in some embodiments, the server may transmit a specific message to the mobile device via the first network to notify that the electric vehicle charging equipment has been bound by another account. When the electric vehicle charging equipment is not bound to any account (No in step S830), in step S840, the server provides an interface to the mobile device through the application program for setting account information, and in step S850, the server creates a specific account according to the account information, and sets the electric vehicle charging equipment to accept only the charging requests corresponding to the specific account. It is noted that, the application program will be linked to the specific account after the binding is complete. Then, in step S860, the mobile device sets a payment information through the application program. It is understood that, in some embodiments, the payment information may be a credit card information. In some embodiments, the payment information may be a financial account number. Then, in step S870, the server performs a certain period of payment request operation for the specific account according to the payment information. It is reminded that, the aforementioned periodic payment operation can be performed in a fixed period, such as weekly, monthly, quarterly, or yearly. The present invention is not limited to any period.

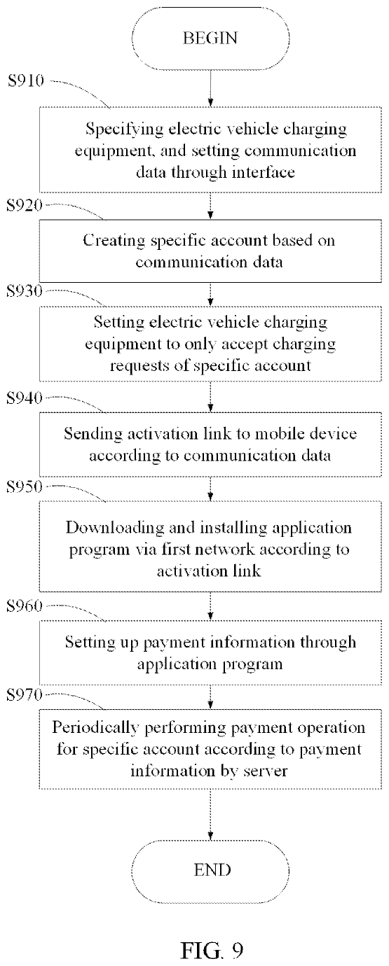

FIG. 9 is a flowchart of another embodiment of a management method for electric vehicle charging equipment of the invention. The management method for electric vehicle charging equipment of the invention is applicable to an electric vehicle charging equipment and a server. In this embodiment, the server will periodically request payment for a specific account of the mobile device.

In step S910, a specific electric vehicle charging equipment is specified from the electric vehicle charging equipment through an interface provided by the server, and communication data is set. It should be reminded that an administrator of the electric vehicle charging equipment can perform the aforementioned operation and setting through the interface provided by the server. In some embodiments, the communication data comprises a phone number, and/or an email address. In step S920, the server creates a specific account according to the communication data, and in step S930, sets the specific electric vehicle charging equipment can only accept charging requests corresponding to the specific account. Then, in step S940, the server transmits an activation link to a mobile device corresponding to a user according to the communication data. In step S950, the mobile device downloads and installs an application program via a network according to the activation link. It is noted that, when the application program is installed on the mobile device, the application program will automatically link and bind to the specific account. In step S960, the mobile device sets payment information through the application program. It is understood that, in some embodiments, the payment information may be a credit card information. In some embodiments, the payment information may be a financial account number. Then, in step S970, the server performs a certain period of payment request operation for the specific account according to the payment information. It is to be reminded that the aforementioned periodic collection operation can be performed in a fixed period, such as weekly, monthly, quarterly, or yearly. The present invention is not limited to any period.

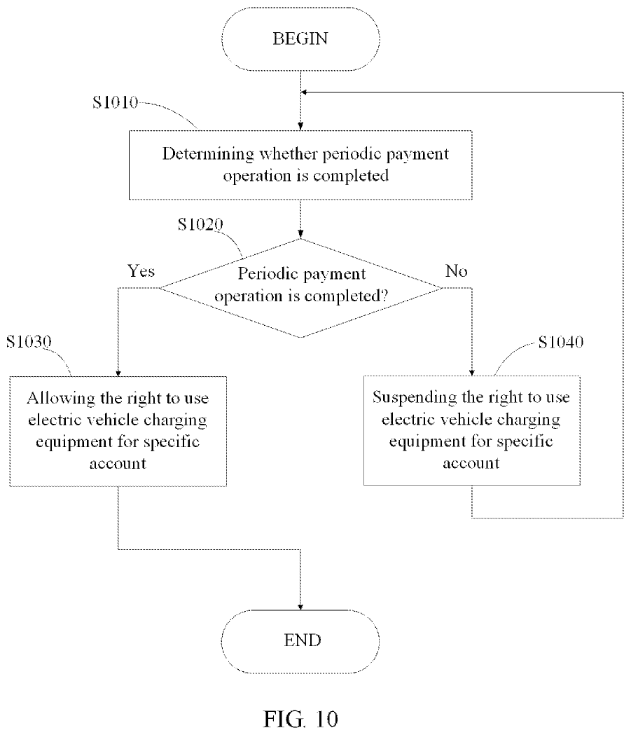

FIG. 10 is a flowchart of another embodiment of a management method for electric vehicle charging equipment of the invention. The management method for electric vehicle charging equipment of the invention is applicable to an electric vehicle charging equipment and a server. In this embodiment, the server may determine the right to use the electric vehicle charging equipment for a specific account according to the execution of the regular payment request operation.

In step S1010, the server determines whether the regular payment request corresponding to the specific account is completed. When the periodic payment request corresponding to the specific account is completed (Yes in step S1020), in step S1030, the specific account is allowed to use the electric vehicle charging equipment. When the regular payment request corresponding to the specific account has not been completed (No in step S1020), in step S1040, the use right of the specific account for the electric vehicle charging equipment is suspended. The right to use the electric vehicle charging equipment for a specific account will not be restored until the regular collection operation is completed.

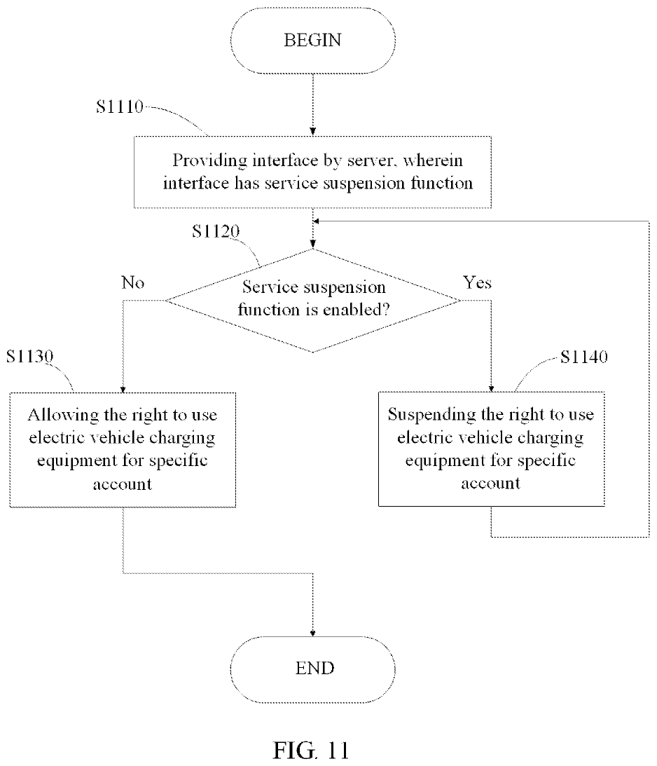

FIG. 11 is a flowchart of another embodiment of a management method for electric vehicle charging equipment of the invention. The management method for electric vehicle charging equipment of the invention is applicable to an electric vehicle charging equipment and a server. In this embodiment, the server can provide an interface for the manager of the electric vehicle charging equipment to control the use right of the electric vehicle charging equipment.

In step S1110, the server provides an interface, wherein the interface has a service suspension function. In step S1120, the server determines whether the service suspension function corresponding to the electric vehicle charging equipment is enabled. When the service suspension function corresponding to the electric vehicle charging equipment is not enabled (No in step S1120), in step S1130, the specific account is allowed to use the electric vehicle charging equipment. When the service suspension function corresponding to the electric vehicle charging equipment is enabled (Yes in step S1120), in step S1140, the use right of the specific account for the electric vehicle charging device is suspended until the service suspension function of the corresponding electric vehicle charging equipment is disabled. In other words, when the service is re-activated, the right to use the electric vehicle charging equipment of the specific account will not be restored. It is reminded that, in some embodiments, the administrator may enable the service suspension function of the electric vehicle charging equipment due to some factors, such as the resident's breach of contract, or the occupation of other users' parking spaces. Note that the present invention is not limited to the aforementioned factors.

Management methods and systems for electric vehicle charging equipment of the invention can provide mechanisms for binding specific electric vehicle charging equipment for user, thereby improving the application flexibility of the electric vehicle charging equipment. In communities or other fields where it is not easy to set up electric vehicle charging stations, the invention can help to reduce the difficulty of setting up and manage electric vehicle charging equipment, and meet the charging needs of different users.

Management methods for electric vehicle charging equipment may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A management method for electric vehicle charging equipment, which is applicable to an electric vehicle charging equipment and a server, comprising:
scanning a quick response code of the electric vehicle charging equipment by using an application program of a mobile device, thus to send a binding request of the electric vehicle charging equipment to the server via a first network;
in response to the binding request, determining whether the electric vehicle charging equipment has been bound to any account by the server;
providing an interface to the mobile device to set account information by the server when the electric vehicle charging equipment is not bound to any account; and
creating a specific account based on the account information, and setting the electric vehicle charging equipment to only accept a charging request from the specific account by the server, wherein the application program is linked to the specific account.

2. The method of claim 1, further comprising:
setting up payment information through the application program by the mobile device; and
periodically performing a payment operation for the specific account according to the payment information by the server.

3. The method of claim 2, further comprising:
determining whether the periodic payment operation is completed by the server; and
suspending the right to use the electric vehicle charging equipment for the specific account by the server when the periodic payment operation is not completed.

4. The method of claim 1, further comprising:
providing an interface by the server, wherein the interface has a service suspension function; and
suspending the right to use the electric vehicle charging equipment for the specific account by the server when the service suspension function is enabled.

5. The method of claim 1, further comprising:
scanning the quick response code corresponding to the electric vehicle charging equipment by using the application program, thus to send a charging request corresponding to the electric vehicle charging equipment to the server via the first network; and
in response to the charging request, transmitting a charging authorization instruction to the electric vehicle charging equipment via a second network by the server, so as to allow the electric vehicle charging equipment to perform a charging operation.

6. The method of claim 5, further comprising:
transmitting charging state data corresponding to the charging operation to the server via the second network by the electric vehicle charging equipment; and
transmitting the charging state data to the mobile device by the server via the first network, such that the charging state data is shown in the application program of the mobile device.

7. The method of claim 1, further comprising:
specifying the electric vehicle charging equipment among a plurality of candidate electric vehicle charging equipment, and setting communication data by the server;
creating the specific account based on the communication data, and setting the electric vehicle charging equipment to only accept charging requests of the specific account by the server;
sending an activation link to the mobile device according to the communication data by the server; and
downloading and installing the application program via the first network according to the activation link by the mobile device.

8. The method of claim 7, wherein the communication data comprises a telephone number, or an email address.

9. A management system for electric vehicle charging equipment, comprising:
an electric vehicle charging equipment;
a mobile device scanning a quick response code of the electric vehicle charging equipment by using an application program, thus to transmit a binding request of the electric vehicle charging equipment, and
a server receiving the binding request via a first network, in response to the binding request, determining whether the electric vehicle charging equipment has been bound to any account, providing an interface to the mobile device to set account information when the electric vehicle charging equipment is not bound to any account, creating a specific account based on the account information, and setting the electric vehicle charging equipment to only accept a charging request from the specific account by the server, wherein the application program is linked to the specific account.

10. The system of claim 9, wherein the mobile device sets up a payment information through the application, and the server periodically performs a payment operation for the specific account according to the payment information.

11. The system of claim 10, wherein the server determines whether the periodic payment operation is completed, and suspends the right to use the electric vehicle charging equipment for the specific account when the periodic payment operation is not completed.

12. The system of claim 9, wherein the server provides an interface, wherein the interface has a service suspension function, and suspends the right to use the electric vehicle charging equipment for the specific account when the service suspension function is enabled.

13. The system of claim 9, wherein the mobile device scans the quick response code corresponding to the electric vehicle charging equipment by using the application program, thus to send a charging request corresponding to the electric vehicle charging equipment to the server via the first network, and in response to the charging request, the server transmits a charging authorization instruction to the electric vehicle charging equipment via a second network, so as to allow the electric vehicle charging equipment to perform a charging operation.

14. The system of claim 13, wherein the electric vehicle charging equipment transmits charging state data corresponding to the charging operation to the server via the second network, and the server transmits the charging state data to the mobile device via the first network, such that the charging state data is shown in the application of the mobile device.

15. The system of claim 9, wherein the server specifies the electric vehicle charging equipment among a plurality of candidate electric vehicle charging equipment, and sets communication data, creates the specific account based on the communication data, and sets the electric vehicle charging equipment to only accept charging requests of the specific account, sends an activation link to the mobile device according to the communication data, and the mobile device downloads and installs the application via the first network according to the activation link.

16. The system of claim 15, wherein the communication data comprises a telephone number, or an email address.

17. A machine-readable storage medium comprising a computer program, which, when executed, causes a device to perform an management method for electric vehicle charging equipment, which is applicable to an electric vehicle charging equipment, and a server, wherein the method comprises:
scanning a quick response code of the electric vehicle charging equipment by using an application program of a mobile device, thus to send a binding request of the electric vehicle charging equipment to the server via a first network;
in response to the binding request, determining whether the electric vehicle charging equipment has been bound to any account by the server;
providing an interface to the mobile device to set account information by the server when the electric vehicle charging equipment is not bound to any account; and
creating a specific account based on the account information, and setting the electric vehicle charging equipment to only accept a charging request from the specific account by the server, wherein the application program is linked to the specific account.
